(19) United States
(12) Patent Application Publication
(10) Pub. No.: US 2011/0225892 A1
(43) Pub. Date: Sep. 22, 2011

(54) Pet Door Pest and Debris Barrier

(76) Inventor: Bruce Donald Tierney, Irvine, CA (US)

(21) Appl. No.: 13/050,869

(22) Filed: Mar. 17, 2011

Related U.S. Application Data
(60) Provisional application No. 61/315,939, filed on Mar. 20, 2010.

(51) Int. Cl. E06B 9/52; E06B 7/16

(52) U.S. Cl. 49/472; 49/506

(57) ABSTRACT

A barrier device preventing access of pests such as mosquitoes, flies, and other small animals as well as debris between a panel pet door and a screen door by providing a seal between the panel pet door and the screen door. The barrier material may have ribs for the purpose of added stiffening or as a guide for adjusting the reach of the barrier. A stopping device may be used to ensure the screen door is closed to a location where good contact is made with the barrier device.

### CROSS-REFERENCE TO RELATED APPLICATION

This utility patent application claims priority to U.S. Provisional Patent Application No. 61/315,939, filed on Mar. 20, 2010, entitled “Pet Door Bug and Debris Blocker,” the benefit of which is claimed under 35 U.S.C. 119, and is further incorporated herein by reference.

### FIELD OF THE INVENTION

The present invention relates generally to pet doors and screen doors and more particularly to blocking the entry of bugs/insects, small animals, dirt, and unwanted extraneous materials entering the gap between a pet door and a screen door.

### BACKGROUND

Panel pet doors for sliding doors are installed in the existing tracks of a sliding door to allow a pet (typically a dog or cat) to enter or exit a home through a pet door.

An example of a panel pet door is described in the following U.S. patents entitled “Adjustable Pet Door” to E. Alan Lethers: 7363956, 7063123, and 6691483, each of which is hereby incorporated herein by reference in its entirety.

The panel pet door shown in FIG. 1, item 3 is often similar in height to the sliding door 1 and is placed in the same sliding rails as the sliding door. The pet door 4 is located near the bottom of the panel pet door 3 providing access for the pet into or out of the home.

When a panel pet door is installed adjacent to a sliding door, the screen door 2 must be left open the width 5 of the pet door opening to prevent the screen door from blocking the passage of the pet into or out of the home. On a warm day, a sliding door may be opened to allow fresh air to enter the home, and with the screen door only partially closed, a large gap 6 exists between the panel pet door 3 and the partially closed screen door 2. This gap is often 3 inches wide by approximately 7 feet tall (over 250 square inches) allowing bugs/insects (mosquitoes, flies, lizards, spiders, etc.) and other extraneous materials including leaves and more to enter the home.

Due to the wide variation in pet doors and sliding door/screen door combinations, there is also a wide variation in the width of the gap between the screen door and the pet door. Double paned sliding glass doors for example, typically result in a larger gap than single paned sliding doors. For this reason, there is a need for a solution that supports easy customization of gap width for each pet door/screen door combination.

Since an embodiment providing a solution to this gap occurs adjacent to where a person walks in and out of the sliding door, there is a need for a solution that will minimize the risk of injury if the person accidentally bumps into the invention.

### BRIEF SUMMARY OF THE INVENTION

One aspect of this invention addresses the need for blocking the gap between the panel pet door and the partially closed screen door as described above. As a result of this invention, which in one embodiment may act as a barrier, bugs/insects (such as mosquitoes, flies, lizards, spiders, etc.) and leaves, etc. are blocked from entering the home while allowing the sliding door to remain open for the exchange of air into and out of the home. FIG. 2 illustrates one embodiment blocking the gap between the screen door and the panel pet door with a projecting flange 7, also referred to as a barrier.

In one embodiment, the barrier 7 is made of a flexible material to give a soft and quiet contact to the screen door when closed and to accommodate variation in the contact of the screen door to the barrier by bending to provide a seal throughout the length of the barrier. In another embodiment, the invention is in a pre-flexed shape so when the screen door is closed and in contact with the invention, the shape bends, but not to the extent that it gives the appearance of bending too far backwards.

In a further embodiment, stiffening ribs exist on the backside of the projecting flange (the side opposite from where the screen door contacts) to provide additional rigidity for the purpose of reducing waviness.

### BRIEF DESCRIPTION OF THE DRAWINGS

The features, objects, and advantages of the present invention will become more apparent from the detailed description set forth below when taken in conjunction with the drawings, in which like reference characters identify correspondingly throughout and wherein:

FIG. 1 depicts a typical scenario prior to the installation of the invention.

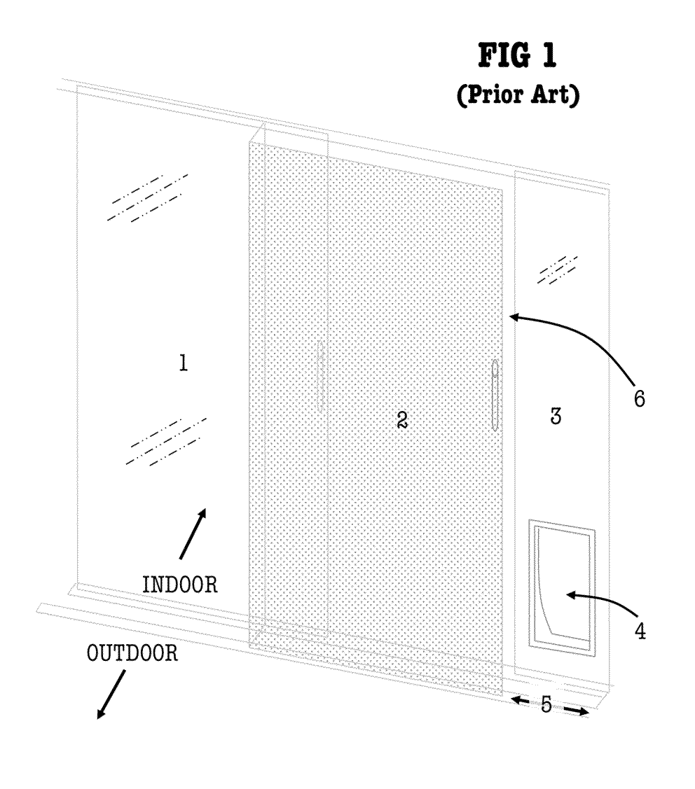

FIG. 2 depicts a typical panel pet door/sliding door/screen door installation with one embodiment of the projecting flange installed and blocking the gap.

FIG. 3 depicts a cross-sectional top-down view of one embodiment of the projecting flange as depicted in FIG. 2.

FIG. 4 depicts a zoomed in view showing one embodiment of the stopping device.

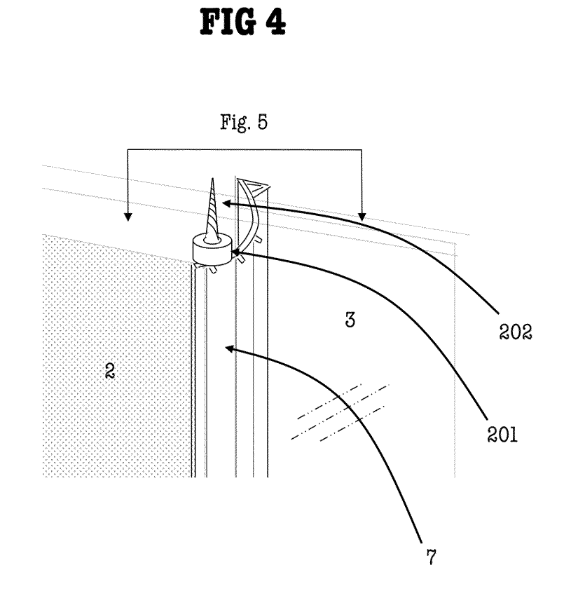

FIG. 5 depicts a top-down view of one embodiment of the barrier showing the screen door stopping device as depicted in FIG. 4.

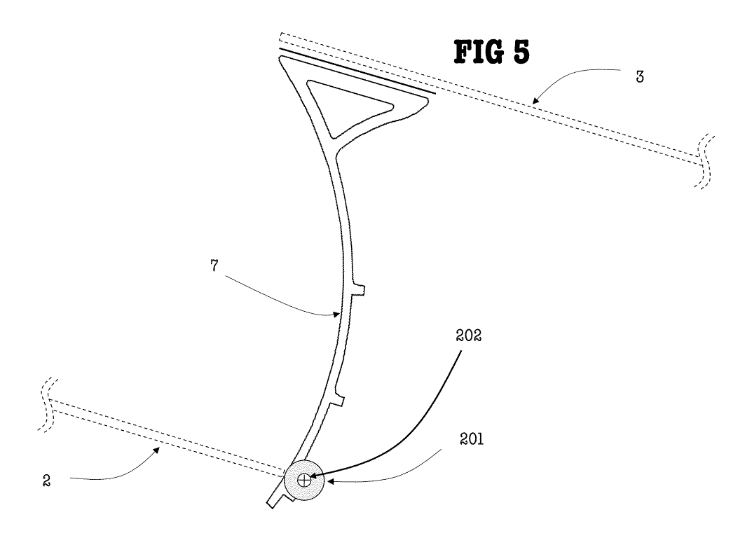

### DETAILED DESCRIPTION OF EXEMPLARY EMBODIMENTS

### Disclosure Overview

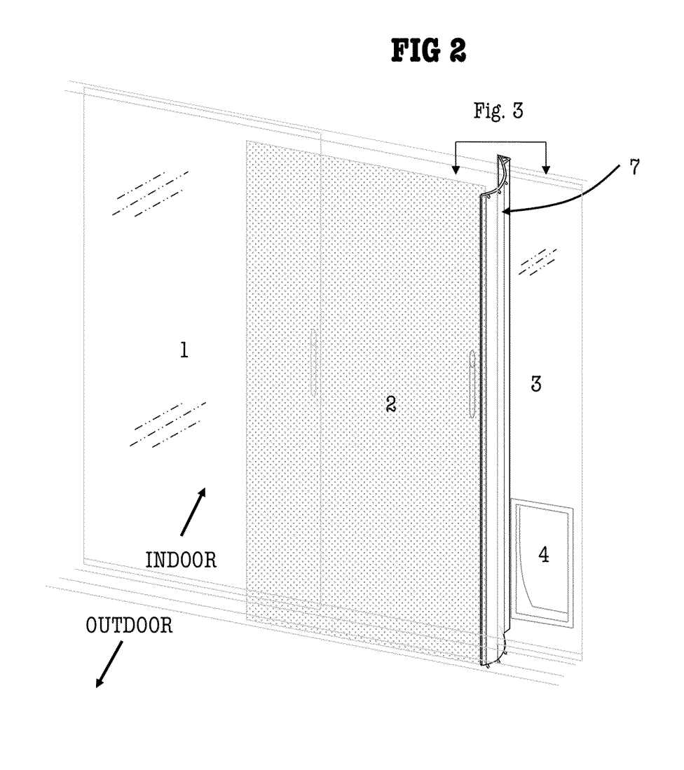

As a result of the gap caused by the installation of panel pet doors, there is a need for a solution that blocks this gap. The solution is provided by this invention. FIG. 2 illustrates one embodiment of the invention installed between a panel pet door/sliding door/screen door arrangement so as to block the gap. In one embodiment, a projecting flange is used as a barrier. In a further embodiment, the projecting flange 7 may be constructed of a flexible material to accommodate variation in the contact of the screen door to the invention by bending to provide a continuous seal throughout the length of the invention.

In yet another embodiment, the projecting flange or barrier may be in a pre-flexed shape so when the screen door is closed and in contact with the invention the shape bends, but not to the extent that it gives the appearance of bending too far backwards. In another embodiment, the base of the projecting flange 7 or barrier (the bottom portion attaching to the panel pet door) provides additional rigidity to minimize flexion, which would otherwise increase undesirable waviness down the length of the invention. Excess waviness provides small openings between the invention and the screen door allowing small bugs/insects or debris to enter.

In another embodiment, stiffening ribs may be provided on the backside of the projecting flange or barrier (the side opposite from where the screen door contacts) to provide additional rigidity for the purpose of reducing waviness.

As is known in the industry, the gap size between the screen door and the panel pet door may vary from one door to the next. The projecting flange or barrier 7 may be provided with multiple guide lines of separation, as shown in the embodiment at locations 102 (3 places in this embodiment), for easy customization with scissors, or any other cutting device, to match the reach of the projecting flange to the gap size between a screen door and panel pet door.

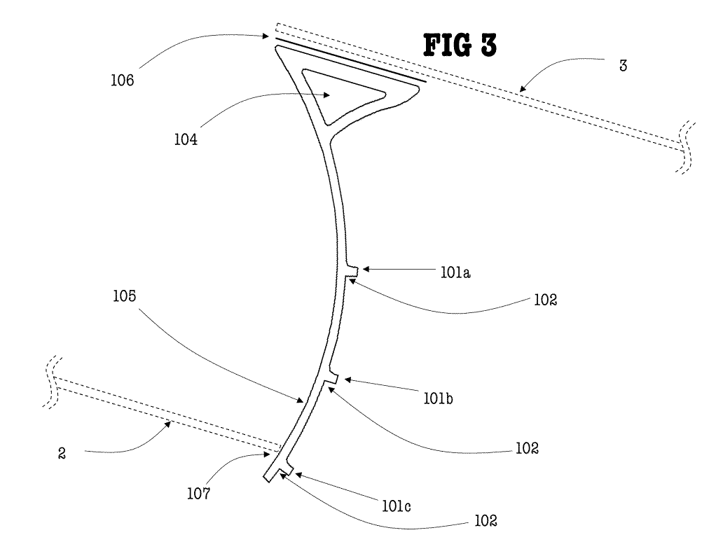

FIG. 3 depicts a cross-sectional top-down view of one embodiment of the invention as depicted in FIG. 2. As shown in FIG. 3, one or more ribs (also referred to as ridges) (101a, 101b, 101c . . . ) generally referred to as ribs 101 occur on the backside (opposite the side where the screen door contacts the invention) in this embodiment. Three ribs are shown in this embodiment of the invention. These ribs provide additional rigidity to minimize waviness along the length of the invention.

The base of one embodiment of the invention includes a hollow closed loop 104, triangular in this embodiment, to provide additional rigidity while keeping the weight to a minimum. The additional rigidity minimizes undesirable waviness, which would otherwise allow bugs/insects and undesirable extraneous material such as leaves to enter through narrow gaps.

Tests were performed with earlier prototypes, demonstrating a flat cross-sectional shape (instead of curved as shown in the “blade” 105) would allow for excessive waviness in some scenarios down the length (perpendicular to the cross section) of the barrier due to manufacturing, shipping or other causes. Increased waviness creates intermittent small openings at location 107, enabling small bugs/insects to fly into or otherwise enter the home. To correct this small opening problem, the side of one embodiment of the blade of the barrier facing the screen door 2 has a curvature 105 extending to establish contact with the screen door when closed to seal these gaps. The curvature of this embodiment provides additional rigidity, beyond what a flat surface could provide, to minimize waviness, thereby reducing small gap openings. Although a flat cross-sectional shape would be acceptable in some embodiments, it may be less desirable in other embodiments where minimizing waviness is important. To further minimize small gaps, the material of one embodiment is designed with flexibility to provide contact throughout the length despite the inherent waviness resulting from manufacturing, and to minimize the contact sound when closing the screen door to contact the invention. When the screen door is closed, the material of this embodiment flexes to reduce waviness while aligning to form continuous contact with the screen door. In some embodiments, a rigid material would also be acceptable.

To minimize the risk of injury when accidentally bumping into the invention when a person walks in or out through the sliding door, the flexible material of some embodiments is selected to flex instead of causing injury as a rigid embodiment might.

In one embodiment, attachment of the projecting flange or barrier 7 to the panel pet door may be performed with dual-sided tape 106.

A stopping device, consisting of 201 and 202 in one embodiment, may be inserted into the frame where the sliding screen door slides, to prevent closing the screen door beyond the projecting flange or barrier 7. In some embodiments, the stopping device may not be required. One embodiment of the stopping device consists of a washer 201, also referred to as a spacer, made of a material softer than metal, such as nylon, that is installed into the top or bottom rail of the sliding door. In one embodiment of the stopping device, the nylon washer is held in place by inserting a screw 202 through the washer and into the frame where the sliding door slides.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A device, comprising:
a projecting flange that blocks access between a first member attached to the projecting flange and an offset second member that abuts the projecting flange.

2. The device of claim 1 wherein the projecting flange comprises material that is one of rigid and flexible.

3. The device of claim 1 further comprising a blade having a cross-section that is one of straight and curved.

4. The device of claim 1 wherein the projecting flange is in one of a horizontal orientation and a vertical orientation.

5. The device of claim 1 wherein the projecting flange comprises an elastomeric material.

6. The device of claim 1 wherein the projecting flange further comprises at least one raised ridge.

7. The device of claim 6 wherein the ridge extends along the projecting flange.

8. The device of claim 6 wherein the ridge stiffens the projecting flange.

9. The device of claim 6 wherein the ridge defines a trimming location to shorten the reach of the blade.

10. The device of claim 6 wherein the blade flexes to accommodate variations in the distance between the blade and the second member.

11. The device of claim 1 further comprising a base, wherein double-sided tape attaches the base to the first member.

12. The device of claim 1 further comprising a base, wherein the base includes a hollow cross-section to provide higher rigidity per weight.

13. The device of claim 1 wherein the first member comprises one of a wall, a door frame, a panel pet door, a window frame, a door, a screen door, a window, and a window screen.

14. The device of claim 1 wherein the second member comprises one of a wall, a door frame, a panel pet door, a window frame, a door, a screen door, a window, and a window screen.

15. The device of claim 1 further comprising a stopping device that controls abutment of the second member with the projecting flange.

16. The device of claim 1 wherein access is blocked to at least one of insects, arachnids, small animals, debris, and extraneous material.

17. A device, comprising:
a vertically-oriented projecting flange that blocks access between a panel pet door attached to the projecting flange and an offset screen door that abuts the projecting flange.

18. The device of claim 17 further comprising a continuous seal between the projecting flange and the screen door, the seal provided by at least one of a curved flexible blade with at least one longitudinal ridge, and a base having a hollow cross section.

19. A method, comprising:
blocking access between a first member and an offset second member by attaching a projecting flange to the first member; and abutting the second member against the projecting flange, whereby a continuous seal is formed between the first member and the second member.

20. A method, comprising:
blocking access between a vertically-oriented panel pet door and an offset screen door by attaching a projecting flange to the panel pet door; and abutting the screen door against the projecting flange, whereby a continuous seal is formed between the panel pet door and the screen door.
